(19) United States
(12) Patent Application Publication
(10) Pub. No.: US 2015/0147545 A1
(43) Pub. Date: May 28, 2015

(54) ELASTOMERIC BILAYER ARMOR INCORPORATING SURFACE-HARDENED SUBSTRATES

(71) Applicants: Charles M. Roland, Waldorf, MD (US); Andrew Saab, Washington, DC (US); Raymond M. Gamache, Indian Head, MD (US); Daniel M. Fragiadakis, Alexandria, VA (US)

(72) Inventors: Charles M. Roland, Waldorf, MD (US); Andrew Saab, Washington, DC (US); Raymond M. Gamache, Indian Head, MD (US); Daniel M. Fragiadakis, Alexandria, VA (US)

(73) Assignee: The Government of the US, as Represented by the Secretary of the Navy, Washington, DC (US)

(21) Appl. No.: 14/552,888

(22) Filed: Nov. 25, 2014

Related U.S. Application Data
(60) Provisional application No. 61/908,524, filed on Nov. 25, 2013.

(51) Int. Cl. B32B 15/06; B32B 15/085

(52) U.S. Cl. CPC B32B 15/06; B32B 15/085; B32B 2255/20; B32B 2250/02; B32B 2571/02; B32B 2307/536
USPC 428/217

(57) ABSTRACT

An armor system is formed of a substrate including an underlying substrate layer of less hard material and including a thin layer of harder material at a first face of the substrate, and an elastomeric material layer positioned at the first face of the substrate. The increased hardness of the thin hard layer increases the penetration resistance of the armor by increasing the elastomer's contribution to penetration resistance. The properties of the substrate can be independently selected, allowing the use of substrates with lower hardness, increasing the armor's ballistic performance, and lowering the weight of the armor.

### CROSS-REFERENCE TO RELATED APPLICATIONS

This Application is a non-provisional of, and claims the benefit under 35 USC 119(e) of, U.S. Provisional Application 61/908,524 filed on Nov. 25, 2013, the entire disclosure of which is incorporated herein by reference.

### BACKGROUND

1. Technical Field

This application is related to armor technology.

2. Related Technology

Effective armor technologies have been sought for many decades to protect humans, vehicles, and systems against projectile weapons and explosive blasts. Elastomeric coatings have been added to traditional armor substrates and structures.

Porter, J. R., Dinan, R. J., Hammons, M. I. , and Knox, K. J., “ Polymer coatings increase blast resistance of existing and temporary structures”, AMPTI AC Quarterly, Vol. 6, No. 4, pp. 47-52, 2002, describes work at the Air Force Research Laboratory, in which a two-component sprayed-on polyurea is added to the one or both surfaces of a composite masonry wall, thus reducing fragmentation (flying debris) of the structure destroyed by a blast.

Composite polyurea coatings have been tested for mitigating the damage from ballistic fragmentation and projectiles. For example, Tekalur, S. A, Shukla, A., and Shivakumar, K., “Blast resistance of polyurea based layered composite materials”, Composite Structures, Vol. 84, No. 3, pp. 271-81, (2008) discloses test results for layered and sandwiched layers of polyurea and E-glass vinyl ester.

Bogoslovov, R. B., Roland, C. M., and Gamache, R. M., “Impact-induced glass transition in elastomeric coatings”, Applied Physics Letters, Vol. 90, pp. 221910-1-221910-3, 2007, which is incorporated by reference herein in its entirety, discloses coating steel with a polybutadiene or polyurea elastomeric layer for impact loading, and compares their failure mechanisms.

Possible mechanisms contributing to the blast and ballistic mitigation of composites are discussed in Xue, Z. and Hutchinson, J. W., “Neck development in metal/elastomer bilayers under dynamic stretchings”, International Journal of Solids and Structures, Vol. 45, No. 3, pp. 3769-78, (2008); in Xue, Z. and Hutchinson, J. W. , “Neck retardation and enhanced energy absorption in metal-elastomer bilayers”, Mechanics of Materials, Vol. 39, pp. 473-487, (2007); and in Malvar, L. J., Crawford, J. E., and Morrill, K. B.; “Use of composites to resist blast”, Journal of Composites for Construction, Vol. 11, No. 6, pp. 601-610, (November/December 2007).

A. Tasdemirci, I. W. Hall, B. A. Gama and M. Guiden, “Stress wave propagation effects in two- and three-layered composite material”, Journal of Composite Materials, Vol. 38, pp. 995-1009, (2004), discloses tests on a three layered composite material with a layer of EPDM rubber between an alumina tile and a glass epoxy composite plate.

Information on the material properties of viscoelastic materials is found in D. I. G. Jones, Handbook of Viscoelastic Vibration Damping, Wiley, 2001, pp. 39-74.

A review of mechanical behavior of viscoelastic materials can also be found in R. N. Capps, “Young's moduli of polyurethanes”, J. Acoustic Society of America, V. 73, No. 6, pp. 2000-2005, June 1983.

### BRIEF SUMMARY

An armor system comprises a substrate including an underlying substrate layer of less hard material and including a thin layer of harder material at a first face of the substrate; an elastomeric material layer positioned at the first face of the substrate. In some examples, the underlying substrate material is steel or aluminum. In some examples, the thin layer of harder material is a harder coating material applied to the underlying substrate, or is formed by surface hardening the substrate material by at least one of carburizing, nitriding, carbonnitriding, nitrocarburizing, boriding, titanium-carbon diffusion, the Toyota diffusion process, flame hardening, induction hardening, laser hardening, electron beam hardening, ion implantation, heat treating with arc lamps, or mechanical work hardening.

The elastomeric material layer can comprise, for example, at least one of polyisobutylene (PIB), PU-1 polyurea, PU-2 polyurea, polynorbornene (PNB) 24, nitrile rubber (NBR), and atactic polypropylene. The elastomeric material layer can be, for example, at least two millimeters thick. The elastomeric material layer can be, for example, at least a few millimeters thick. The underlying substrate material can have, for example, a Brinell hardness of less than 500 Brinell units and the thin harder layer can have a hardness of at least 900 Brinell units. In some examples, the thin harder layer has a hardness of at least 25 Brinell hardness points above that of the underlying substrate material. In some examples, the thin hard layer is formed by oxidizing and polishing the surface of a high hardness steel substrate or an ultra high hardness steel substrate, or by sandblasting and polishing the surface of a high hardness steel substrate or an ultra high hardness steel substrate. In some examples, the thin harder layer has a thickness of between 0.02 mm and 0.05 mm, or between 0.005 inches and 0.01 inches. The properties of the substrate can be selected independently of the thin hard layer and the elastomeric material layer.

### BRIEF DESCRIPTION OF THE DRAWINGS

FIG. 1 shows the isolated V-50 ballistic performance of an elastomeric layer as part of a bilayer armor formed of steel coated with a PU elastomer layer for substrates of different hardness.

FIG. 2 is a cross sectional view of an exemplary armor system having an elastomer layer and a substrate with a thin layer of very hard substrate material facing the elastomer.

FIG. 3 is a cross sectional view of an exemplary armor system having an elastomer layer and a substrate with a thin layer of very hard substrate material facing the elastomer, showing regions of different hardness within the substrate.

FIG. 4 shows the V-50 penetration velocity for elastomer-steel armors and the glass transition temperature for different elastomers.

FIG. 5A, 5B, and 5C show the mechanical loss tangent for PI, PIB, and PU-2, respectively, plotted against the reduced frequency α_{T}×ω in 1/rad.

FIG. 6 is a cross sectional view of an armor structure with a substrate with a thin layer of very hard substrate material and a laminate armor portion with alternating thin metal and elastomer layers.

### DETAILED DESCRIPTION

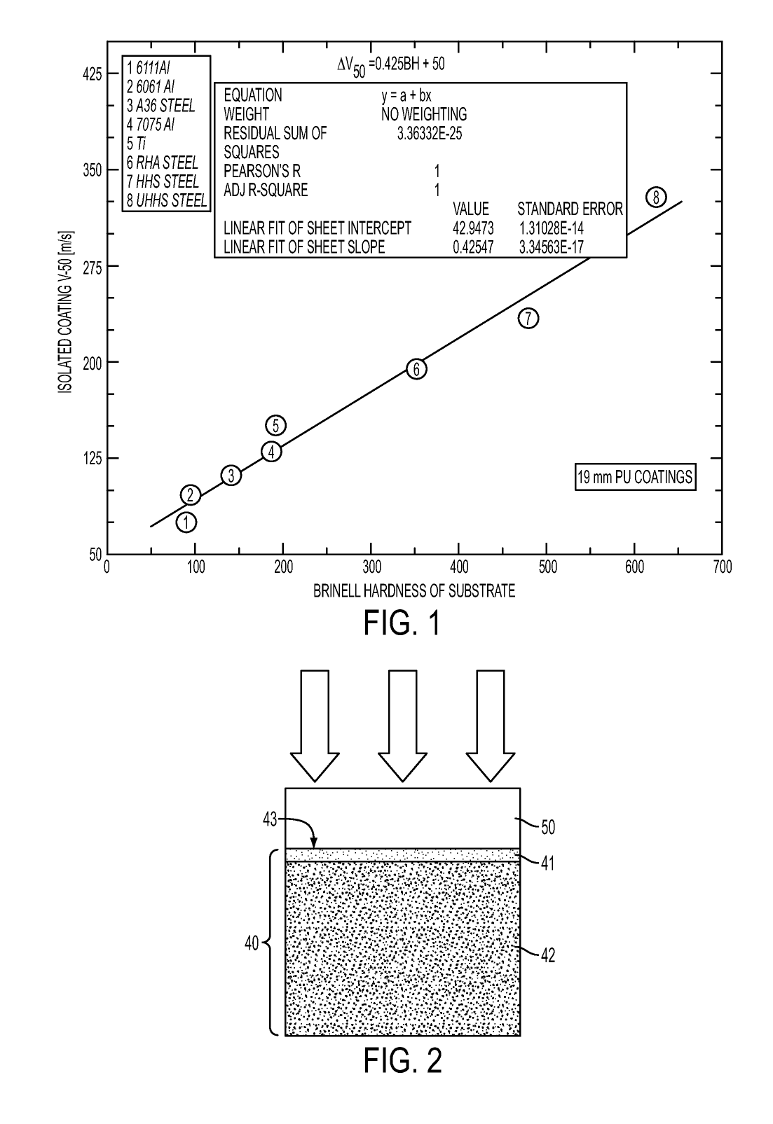

FIG. 1 illustrates improvements in ballistic performance that can be achieved by coating the front (contact) surface of an armor substrate with an elastomeric material. The elastomeric layer faces toward the direction from which incoming projectiles or blast threats are expected to arrive.

For blunt projectiles, the principal advantage of the elastomeric coating or layer is that the elastomeric material undergoes an impact-induced viscoelastomeric phase transition from elastomeric to glassy, with consequent large energy absorption. This requires rapid compression of the elastomer. The hard substrate, in addition to resisting penetration, also allows rapid compression of the coating, so that the elastomer is perturbed at frequencies commensurate with its segmental dynamics. The impact-induced phase transition mechanism implies that the substrate only needs to be stiff enough to avoid out-of-plane bending, which would diminish compression of the coating.

FIG. 1 shows the contribution to the V-50 penetration velocity by the elastomeric layer in a bilayer armor, measured for eight substrate materials coated with a 19 millimeter thick polyurethane coating on the front surface. The V-50 ballistic limit is the velocity at which the projectile is expected to penetrate the armor 50% of the time. The isolated coating V-50 shown in FIG. 1 is the V-50 measured for the coated substrates after subtraction of the corresponding V-50 for the different substrate materials. The figure reveals that the increase in penetration velocity due to the presence of a coating on the substrate depends on the hardness of the substrate. Thus, the elastomer layer's contribution to the armor's ballistic performance can depend on the hardness of the substrate. FIG. 1 reveals that there is a systematic increase in the coating contribution to the penetration resistance of the bilayer armor with increasing substrate hardness. This effect depends on the material hardness, not on the rigidity of the substrate. The V-50 performance does not correlate to, and even may decrease with, an increasing substrate thickness.

As a result, the elastomer layer's contribution to the armor's ballistic performance can be increased by using harder substrates, which typically have higher acoustic impedance, up to a certain point. However, because the hardest materials for substrates are overly brittle, there is an upper limit on the hardness of the armor substrate material beyond which the armor's net ballistic performance will degrade. For example, armor having a Brinell hardness exceeding 500 can have poorer ballistic performance even if the elastomer layer's contribution is enhanced. In addition, the performance of harder steels tends to degrade with increasing thickness, which may be the result of difficulty of manufacturing thick very hard substrates of uniform hardness.

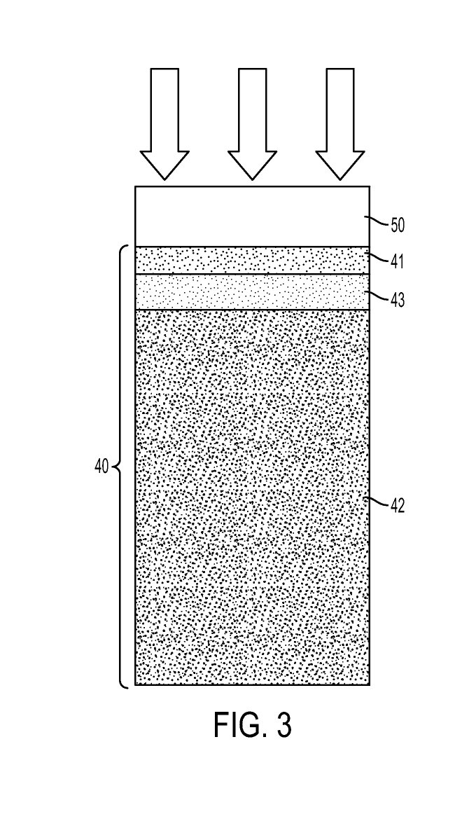

In an exemplary embodiment, an armor system shown in FIG. 2 comprises a substrate 40 and an elastomeric layer 50 positioned on the front surface of the substrate facing toward the incoming projectiles or blasts. The substrate 40 has a thin layer of material 41 that is harder than the underlying substrate material 42, at the front (contact) surface of the substrate facing the elastomeric layer.

The elastomeric layer 50 is in contact with the front surface of the substrate, allowing the very hard surface of the substrate to compress the elastomeric material when the armor is struck with a high velocity projectile. The elastomeric layer can be adhered, chemically attached, or mechanically attached to the front surface of the substrate.

The thin layer of very hard material 41 provides a very hard surface on the face 43 of the substrate 40, substantially improving the ballistic performance (penetration resistance) of the elastomer, without affecting any properties of the underlying metal substrate 42. The result is a net improvement in ballistic performance, apparently due to the high impedance mismatch between the elastomer and the hard surface layer.

In contrast, if the entire substrate were very hard (e.g., with a Brinell hardness of more than 500), it would still impart the same improvement to the elastomeric layer, but other undesirable properties (e.g., brittleness) would reduce the overall effectiveness of the armor.

The thin layer of harder material allows the underlying substrate to be selected based on its independent contribution to the armor's performance. For example, the substrate can be a less hard material that has other desirable characteristics, such as high elongation, toughness, or formability.

For example, the underlying substrate can be steel with a hardness of less than 500 Brinell units, and a thin front layer surface hardened using a nitride or chrome-based substance can have a hardness of more than 900 Brinell units.

As one example, the substrate can be steel, and the thin layer of very hard material can be a nitride coating, a hard chrome coating, a diamond or diamond-like carbon coating, or a thin ceramic coating.

The very hard layer can be very thin. For example, a suitable thickness can be between about 0.02 mm (0.0008 inches) and 0.05 mm (0.02 inches).

The substrate can be any material that can function as a substrate for the elastomeric coating. Metals such as aluminum or steel can be suitable. Where areal density is a factor, titanium or aluminum substrates can be used instead of steel. The lack of hardness of a substrate can be overcome by addition of a hard coating on the front side of the metal substrate.

The elastomeric polymer is at least a few millimeters in thickness. The elastomeric polymer material can be adhered or otherwise attached to the steel substrate.

In some embodiments, the substrate with the thin hard surface layer is formed by first forming the substrate and then adding a harder layer or coating to the substrate. In other embodiments, it is formed by treating the surface of the substrate to harden a thin layer of the substrate itself. In other embodiments, it is formed by adhering or mechanically attaching the thin hard layer to underlying substrate.

Different surface hardening techniques for steel can be used. Hardfacing techniques include fusion hardfacing (welded overlay) and thermal spray (nonfusion bonded overlay). Hard coatings can be added by electrochemical plating, chemical vapor deposition (nonfusion-bonded overlay), or ion mixing. Thin films can be added by physical vapor deposition, ion plating, or sputtering. The surface of the substrate can be hardened by diffusion methods, which involve the chemical modification of a surface. Diffusion methods include carburizing, nitriding, carbonnitriding, nitrocarburizing, boriding, titanium-carbon diffusion, or the Toyota diffusion process. Selective-hardening methods include flame hardening, induction hardening, laser hardening, electron beam hardening, ion implantation, selective carburizing and nitriding, and heat treating with arc lamps. Mechanical work hardening methods such as peening can also harden the surface of the substrate.

When the surface of the substrate is hardened, the substrate can have a hardness profile that gradually decreases from a maximum hardness at or near the surface to the lower hardness of the underlying substrate material. See, for example, the substrate 40 in FIG. 3, showing a region or layer of very hard material 41, a region 43 of decreasing hardness, and the underlying lower hardness substrate material 42. Thus, the substrate can be considered to be several layers, one of which is a top layer having hardness values in a higher range than the underlying substrate. Of course, the treatment used to impart hardening to the metal surface should not negatively affect other properties of the substrate. For example, a very high temperature used for surface hardening may affect the temper (crystal structure) of the metal in an adverse manner.

Some suitable materials for the elastomeric polymer positioned at the front surface of the substrate are those that undergo transition from elastomeric to glassy, and thus, while rubbery initially and subsequent to impact, they fail in a brittle or glassy manner when struck by a high speed projectile. To determine which elastomeric materials would provide increased penetration resistance, HHS steel plates were coated with polyisobutylene (PIB), two variations of elastomeric polyurea (PU-1 and PU-2), polynorbornene (PNB), nitrile rubber (NBR), 1,4-polybutadiene (PB), synthetic 1,4 polyisoprene (PI), and natural 1,4 polyisoprene rubber (NR), respectively. The HHS steel was formed in accordance with MIL-A-46100. Ballistic testing was accomplished according to MIL-STD-662F against 0.50 caliber fragment simulating projectiles. The HHS steel plates coated with polyisobutylene (PIB) 21, the PU-1 polyurea 22, the PU-2 polyurea 23, the polynorbornene (PNB) 24, and the nitrile rubber (NBR) 25, are each shown with a solid square, indicating that they failed in a brittle fashion, with the damage zone limited to the immediate area of impact. The 1,4-polybutadiene (PB) 26, the synthetic 1,4 polyisoprene (PI) 27, and natural 1,4 polyisoprene rubber (NR) 28 experienced rubbery failure, with substantial tearing and stretching of the coating. Thus, PNB, PIB, PU-2, PU-1, and NBR are believed to be good choices for this application.

Some of the suitable elastomeric materials have a glass transition temperature close to, but less than, the expected operating temperature of the armor. For these materials, the glass transition temperature of the material is believed to be a significant factor in achieving a high ballistic limit. When the glass transition temperature is less than, but sufficiently close to, the operational temperature, the impact of the projectile induces a transition to the viscoelastic glassy state. The transition to the viscoelastic glassy state is accompanied by large energy absorption and brittle fracture of the now-glassy elastomeric material, which significantly reduces the kinetic energy of the projectile and hence its ability to penetrate the armor.

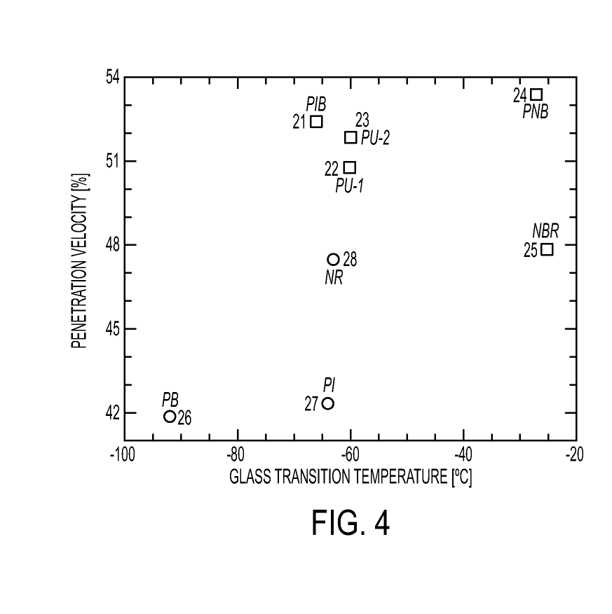

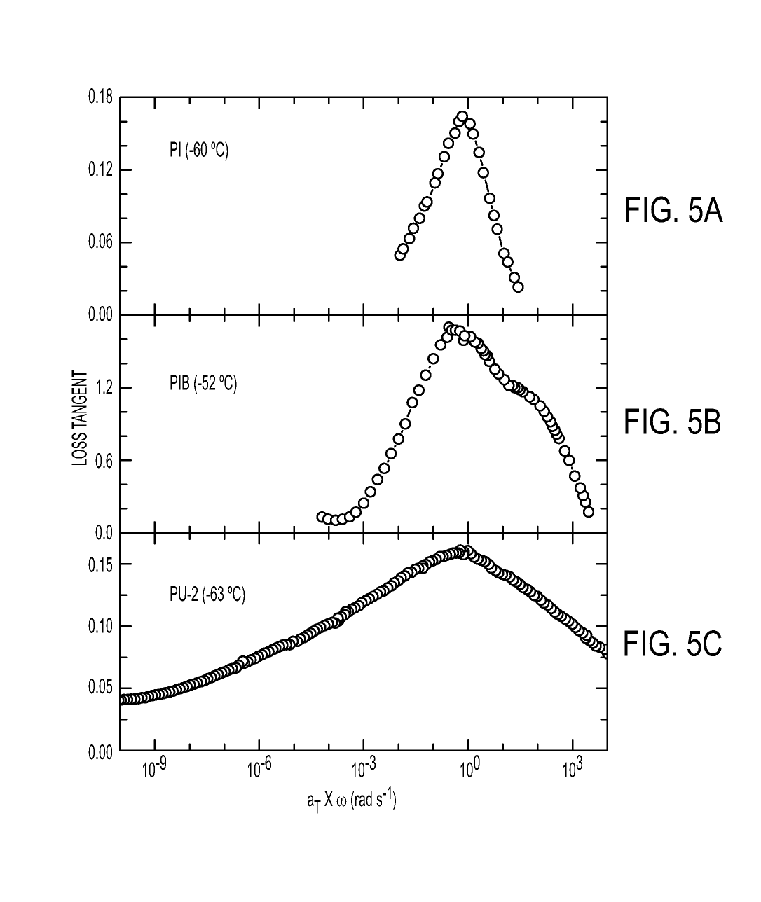

Other suitable elastomeric materials, although their glass transition temperature is not very close to the test or operating temperature of the armor, have a very broad transition zone in their characteristic loss tangent curves. As a result, when the elastomeric armor with a hard substrate is struck by a high speed projectile, the elastomeric material absorbs a large amount of energy from the projectile and fails in a brittle fashion. The glass transition temperatures of the PIB, PU-1 and PU-2 coatings shown in FIG. 4 are in the range of −60 degrees C., so are not especially high. FIG. 5A, 5B, and 5C, show the mechanical loss tangent for PI, PIB, and PU-2, respectively, plotted against the reduced frequency α_{T}×ω in 1/rad, in which ω is frequency in radians, and α_{T} is the shift factor in a shift factor equation for modeling the frequency and temperature equivalence of viscoelastic materials, such as the Williams-Landel-Ferry (WLF) equation, the Vogel-Fulcher equation, or another shift factor equation. The reduced frequency 60 _{T}×ω takes into account both the frequency and temperature. At the high temperature/low frequency portion at the right of each plot, the materials exhibit rubbery properties. At the low temperature/high frequency portion at the left of each plot, the materials exhibit glassy properties. A transitional region lies between the rubbery and glassy regions. The curve in FIG. 5C for PU-2 is the superposition of measurements over a range of temperature. Although the PU-2 material is thermo-rheologically complex and the shape of the superposed curve is only approximate, the time-temperature superpositioning gives an indication of the breadth of the dispersion. For FIG. 5B, the data for the polyisobutylene (PIB) curve was obtained over a broad frequency range by combining transient and dynamic mechanical spectroscopies. In the FIG. 5A curve for 1,4-polyisoprene (PI), the dispersion is narrow, and can be measured in a single experiment without time-temperature superpositioning. The height of the loss tangent peak varies with temperature, specifically by decreasing with proximity to T_{g}, which is believed to be a consequence of the thermo-rheological complexity. The transition regions for PIB (FIG. 5B) and PU-2 (FIG. 5C) are both broader than that of PI (FIG. 5A), which appears to correspond to the glassy/brittle failure of the PIB and PU-2 coatings and the rubbery failure of the PI coating as shown in FIG. 4.

The low frequency stress strain data on the elastomers for FIG. 5A-5C are obtained in a tensile geometry using an Instron 550R. The glass transition temperatures shown in FIG. 4 are measured by scanning calorimetry (with a TA Instruments Q100), with samples cooled below the glass transition temperature T_{g} at a rate of 10 degrees Kelvin per minute and data taken subsequently heating at the same rate.

Further discussion about brittle failure of elastomeric armor materials is found in C. M. Roland, D. Fragiadakis, and R. M. Gamache, “Elastomer Steel Laminate Armor”, Composite Structures, Vol. 92, pp. 1059-1064, 2010 and U.S. Pat. No. 8,746,122 to Roland et al., each of which is incorporated herein in its entirety.

In an example embodiment, a 0.20 inch thick substrate of high hardness steel was surfaced hardened by polishing to remove the oxidized layer, and then coated with a polyurea elastomeric material. The V-50 penetration velocity for a .50 caliber fragment-simulating-projectile (fsp) was 2776 plus or minus 4 feet per second. Without polishing, the softer substrate surface causes the V-50 penetration velocity to be lower, 2735 plus or minus 14 feet per second In another example, a 0.20 inch thick substrate of high hardness steel was surfaced hardened by sandblasting and polishing, and coated with an elastomeric material. In an example embodiment, a 0.21 inch thick substrate of ultra high hardness steel was surfaced hardened by oxidation and polishing, and coated with an elastomeric material. The V-50 penetration velocity was 2858 plus or minus 13 feet per second, an improvement over the untreated substrate, for which the V-50 penetration velocity was 2795 plus or minus 40 feet per second. The polishing increases the surface hardness by an estimated 25 Brinell units (over that of the oxidized, unpolished surface of the substrate).

In another example, a HHS substrate as received was coated with a polyurea elastomer, and a HHS substrate had a hard chrome coating applied prior to application of the polyurea coating. The V-50 penetration velocity of the former was 2586 feet per second, and for the latter, the V-50 penetration velocity was 2786 feet per second.

In another example HHS substrates of two thicknesses were tested with 0.11″ polyurea elastomeric coatings. The substrates were used as received and after deposition of a diamond-like carbon coating. The coated test pieces using conventional HHS had V-50 equal to 2221 and 2437 feet per second. The coated test pieces using HHS onto which a diamond-like carbon coating was deposited prior to application of the polyurea had V-50 equal to 2350 and 2625 feet per second.

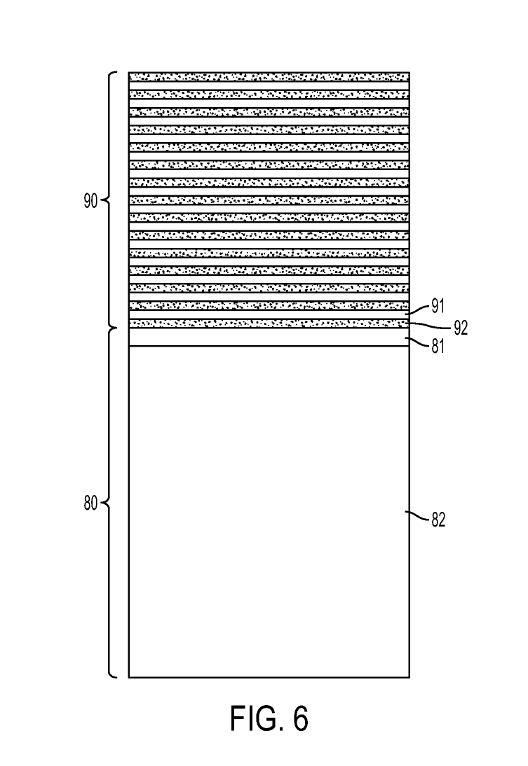

The elastomeric polymer coating can be formed of more than one layer of different materials. In some examples, a laminate of alternating hard and soft elastomeric materials is positioned at the front surface of the substrate. FIG. 6 illustrates an armor having a substrate 80 with a thin hard substrate layer 81 and an underlying less hard substrate material 82, and a laminate armor portion 90 with alternating elastomer layers 92 and hard layers 91 positioned on front surface of the substrate, with one of the elastomeric layers 92 in contact with a face of the substrate thin very hard layer 81.

The invention has been described with reference to certain preferred embodiments. It will be understood, however, that the invention is not limited to the preferred embodiments discussed above, and that modification and variations are possible within the scope of the appended claims.

What is claimed as new and desired to be protected by Letters Patent of the United States is:

1. An armor system comprising:
a substrate including an underlying substrate layer of less hard material and including a thin layer of harder material at a first face of the substrate;
an elastomeric material layer positioned at the first face of the substrate.

2. The armor system of claim 1, wherein the underlying substrate material is steel.

3. The armor system of claim 1, wherein the underlying substrate material is aluminum.

4. The armor system of claim 1, wherein the thin layer of harder material is a harder coating material applied to the underlying substrate.

5. The armor system of claim 1, wherein the thin layer of harder material is formed by surface hardening the substrate material by at least one of carburizing, nitriding, carbonnitriding, nitrocarburizing, boriding, titanium-carbon diffusion, the Toyota diffusion process, flame hardening, induction hardening, laser hardening, electron beam hardening, ion implantation, heat treating with arc lamps, or mechanical work hardening.

6. The armor system of claim 1 wherein the elastomeric material layer comprises at least one of polyisobutylene (PIB), PU-1 polyurea, PU-2 polyurea, polynorbornene (PNB) 24, nitrile rubber (NBR), and atactic polypropylene.

7. The armor system of claim 1, wherein the elastomeric material layer is at least two millimeters thick.

8. The armor system of claim 1, wherein the elastomeric material layer is at least a few millimeters thick.

9. The armor system of claim 1, wherein the underlying substrate material has a Brinell hardness of less than 500 Brinell units and the thin harder layer has a hardness of at least 900 Brinell units.

10. The armor system of claim 1, wherein the thin harder layer has a hardness of at least 25 Brinell hardness points above that of the underlying substrate material.

11. The armor system of claim 1, wherein the thin hard layer is formed by oxidizing and polishing the surface of a high hardness steel substrate.

12. The armor system of claim 1, wherein the thin hard layer is formed by sandblasting and polishing the surface of a high hardness steel substrate.

13. The armor system of claim 1, wherein the thin hard layer is formed by oxidizing and polishing the surface of an ultra high hardness steel substrate.
The armor system of claim 1, wherein the thin hard layer is formed by sandblasting and polishing the surface of an ultra high hardness steel substrate.

14. The armor system of claim 1, wherein the thin harder layer has a thickness of between 0.02 mm and 0.05 mm.

15. The armor system of claim 1, wherein the thin harder layer has a thickness between 0.005 inches and 0.01 inches.

16. The armor system of claim 1, wherein the properties of the substrate are selected independently of the thin hard layer and the elastomeric material layer.
